(19) United States
(12) Patent Application Publication
(10) Pub. No.: US 2010/0170856 A1
(43) Pub. Date: Jul. 8, 2010

(54) IMPROVEMENT SEPARATION OF SOLIDS FROM LIQUIDS BY THE USE OF QUICK INVERTING AND DISPERSING FLOCCULANTS

(76) Inventor: Merle L. Branning, Plano, IL (US)

Correspondence Address: NALCO COMPANY, 1601 W. DIEHL ROAD, NAPERVILLE, IL, 60563-1198, US

(21) Appl. No.: 12/349,286

(22) Filed: Jan. 6, 2009

(51) Int. Cl. C02F 1/52

(52) U.S. Cl. 210/728

(57) ABSTRACT

This invention is directed to methods for quickly inverting and dispersing a flocculant in a digestion process prior to the production of an aqueous slurry to achieve settlement of solids and clarification of the slurry water. In particular, this invention relates to methods for quickly inverting a flocculant-containing emulsion in-line without significantly destabilizing the emulsion. The methods comprise dosing water with at least one water-in-oil emulsion containing at least one of a flocculant polymer and a hydrophilic surfactant and subjecting the water and emulsion to a high shear, turbulent reverse flow, such that the combination of the surfactant and shear synergistically inverts the emulsion, so the flocculant may be directly injected.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### FIELD OF THE INVENTION

This invention relates to methods for quickly inverting and dispersing a flocculant to achieve separation of solids from liquid in slurries. In particular, this invention relates to methods for quickly inverting a liquid flocculant without significantly destabilizing the emulsion that contains the flocculant then adding the quick inverting flocculant. The methods employ the synergistic combination of a surfactant present in the flocculant-containing emulsion with high shear provided by, e.g., an in-line mixer, to cause the flocculant to be released for direct addition or injection to a solid and liquid separation application.

The present invention has application in, e.g., mineral and mining processing operations, paper and pulp manufacturing, reclamation processes, waste treatment, and any other suitable application requiring solid-liquid separation.

### BACKGROUND OF THE INVENTION

A number of industrial processes, including mining and mineral operations, conventionally rely on flocculants to help separate inorganic and organic solids from slurries so that the processing water may be recycled. Flocculants are generally organic polymers that function by aggregating the solids, either by charge neutralization or bridging mechanisms, so they settle in the slurry, resulting in a layer of settled solids and a clarified liquid, the latter being recyclable to the process. Flocculants are commercially available as water-in-oil emulsions with the flocculant polymers coiled within the water phase.

Before the flocculent can act upon the solids in the slurry, however, the emulsion must undergo inversion—a process wherein the bulk phase of the emulsion is inverted from oil to water and the flocculant polymer is released into an aqueous system where it can exert its flocculant activity. Inversion generally requires adding a surfactant to water and agitating the resulting mixture until the oil phase inverts. Inversion is completed when the polymeric flocculant has been released into the water.

Typically, the inversion process is both labor-intensive and time consuming, as it takes one hour or more to complete using specialized equipment—such as tanks, feeders, and pumps—and manpower to carefully weigh out the components and monitor the process.

U.S. Pat. No. 3,734,873 to Anderson et al. discloses a method for dissolving water-soluble vinyl addition polymers into water more rapidly than the solid form of the polymer. The method comprises preparing a water-in-oil emulsion that includes a surfactant and that inverts within one hour of being subjected to agitation. U.S. Pat. No. 5,679,740 to Heitner teaches the use of carboxylated ethoxylated nonyl phenols and alcohols as mechanically stable inverting agents for emulsion polymers. The Heitner emulsions invert after being “stirred” with a paddle stirrer for at least five minutes. However, neither of these methods attains an almost immediate inversion. Nor do the methods mention usage levels or high shear conditions or direct injection of the polymer to a given application. Nor do these methods eliminate the manpower, time, or equipment required by conventional methods.

Thus, there exists a continued need for a method of quickly inverting and dispersing an emulsified flocculant into a solid-liquid separation application.

### SUMMARY OF THE INVENTION

This invention is directed to a method for rapidly and almost immediately inverting a flocculant-containing emulsion by the synergistic use of turbulent flow and a surfactant present in the emulsion.

In its principal aspect, a method is provided for quickly inverting a flocculant-containing emulsion and dispersing the flocculant in the digestion process prior to the development of a slurry. The method comprises: (a) dosing water with an effective flocculating amount of at least one water-in-oil emulsion comprising at least one flocculent and at least one hydrophilic surfactant, the surfactant being present in the emulsion at a concentration of from about 1 to about 10 percent, by weight; (b) subjecting the water and the emulsion to high shear, comprising a turbulent reverse flow, at a sufficient pressure and for a sufficient time for the at least one emulsion to invert and release the at least one flocculant into the water; and (c) adding the released at least one flocculant to an aqueous slurry for separation of solids from liquid in the slurry.

In its second aspect, the invention is a method for direct injection or addition of a flocculant to a solid-liquid separation application. The method provides for quick inversion of a flocculating-containing emulsion in situ so the flocculant is released directly into the application. The method comprises feeding into an aqueous slurry an effective flocculating amount of at least one water-in-oil emulsion, each emulsion comprising at least one water-soluble organic flocculant polymer and at least one hydrophilic surfactant; and subjecting the slurry and the at least one emulsion to an effective amount of high shear for sufficient time and at sufficient pressure, such that the at least one emulsion inverts in situ and the at least one flocculant is released into the slurry for solids/liquid separation. The flocculant comprises polymers selected from the group consisting of copolymers, homopolymers and terpolymers comprising from 0.01 to 100 mole percent of any vinyl-containing functional monomer such as acrylamide or sodium acrylate, as examples. The polymers have a reduced specific viscosity of from less than 1 to about 50 deciliters per gram or greater.

### DETAILED DESCRIPTION OF THE INVENTION

For purposes of this patent application, the following terms have the definitions set forth below:

“Aggregate” refers to a mixture of sand and gravel.

“Alkyl” means a fully saturated hydrocarbon radical of from about 1 to about 40 carbon atoms, which may be linear or branched.

“Anionic polymer” means a polymer having a net negative charge, such as a copolymer of acrylamide and sodium acrylate.

“APTAC” means acrylamido propyl trimethyl ammonium chloride.

“Cationic polymer” means a polymer having a net positive charge, such as homopolymers, copolymers, and terpolymers comprising diallyldimethyl ammonium chloride, dimethylaminoethyl/acrylate methyl chloride quaternary ammonium salt acrylamide, amines, amidoamines, ethyleneimine, EDC/NH₃, acrylic acid, acrylate, vinylamine, vinylformamide, vinyl acetate, and vinyl alcohol, as examples.

“DADMAC” refers to diallyldimethyl ammonium chloride.

“DMAEM.MCQ” means dimethylaminoethylmethacrylate methyl chloride quaternary.

“DMAEA.MCQ” means dimethylaminoethylacrylate methyl chloride quaternary.

“EDC/NH₃” means a polymer comprising ethylene dichloride and ammonium salt.

“EO” means ethylene oxide.

“HLB” refers to hydrophobic-lipophilic balance.

“Mannich reaction” means a reaction of active methylene compounds with formaldehyde and ammonia or primary or secondary aminos to give beta-aminocarbonyl components.

“MAPTAC” means methacrylamido propyl trimethyl ammonium chloride.

“Mineral slurry” refers to aqueous suspensions of minerals and other particles from mineral and mining operations, where such solids are selected from the group consisting of coal, clean coal, bauxite, iron ore, copper ore, sand, gravel, clay, dirt, lead/zinc, phosphate rock, taconite, beryllium, trona, kaolin, titania, uranium, precious metals, and the like.

“Monomer” means a carbon-based molecule or compound, which has specific functional groups, a simple structure, and relatively low molecular weight, such that it is capable of conversion to polymers by combination with itself or other similar molecules or compounds.

“PO” means propylene oxide.

“Polyacrylate” means the salt neutralized form of polyacrylic acid (salt can be sodium, potassium, etc).

“Polyacrylic acid” means polymers from acrylic acid or hydrolysis of polyacrylamide.

“Polyamines” means polymers containing amine functionality, such as dimethylamine-epichlorohydrin polymers. These polymers can be “crosslinked” with ammonia, or they may be linear.

“Poly (DADMAC)” means polymers from diallyldimethyl ammonium chloride.

“Poly (DMAEM-MCQ)” means a homopolymer of dimethylaminoethylmethacrylate methyl chloride quaternary.

“Poly (DMAEA-MCQ)” means a homopolymer of dimethylaminoethylacrylate methyl chloride quaternary.

“Polyvinylamine” means polymers made from the polymerization of N-vinyl formamide which polymers are then hydrolyzed. This also includes copolymers of vinylamine with monomers such as vinylformamide, vinyl acetate, vinyl alcohol and acrylamide.

“RSV” stands for “Reduced Specific Viscosity.” RSV is an indication of polymer chain length and average molecular weight which, in turn, indicate the extent of polymerization. RSV is measured at a given polymer concentration in a standard electrolyte solution and temperature and is calculated as follows:

$$RSV = \frac{[ ( η / {η}_{o} ) ] - 1}{c}$$

$$η = viscosity of polymer solution , based on flow times ( seconds )$$

$${η}_{o} = viscosity of solvent at the same temperature , based on flow times ( seconds )$$

$$c = concentration of polymer in solution .$$

In this patent application, concentration “c” has units of gram/100 milliliters (g/mL) or gram/deciliter (g/dL), and RSV has units of deciliter/gram (dL/g). RSV was measured at a pH of 8-9 on polymer concentrations of 0.045%, by weight, in 1 M sodium nitrate solution as the solvent. The viscosities η and η₀ were measured using a Cannon Ubbelohde semi-micro viscometer; size 75, with the viscometer mounted in a perfectly vertical position in a constant temperature bath adjusted to 30±0.02 degrees C. The error inherent in the calculation of RSV is about 2 dL/g. A finding that two polymers of the same composition have similar RSV's, measured under identical conditions, indicates that the polymers have similar molecular weights and should, therefore, give the same performance or activity in a given application.

“Surfactant” means any compound that reduces surface tension when dissolved in water or water solutions or that reduces interfacial tension between two liquids, or between a liquid and a solid.

As indicated, in its first aspect, this invention relates to a method for quickly inverting a flocculant-containing emulsion so it readily releases the flocculent for solids separation in slurries. The method comprises dosing water with an effective flocculating amount of at least one water-in-oil emulsion, each emulsion comprising at least one flocculant and at least one hydrophilic surfactant and subjecting the emulsion-containing water to a sufficient amount of shear at sufficient pressure and for a sufficient time for the at least one emulsion to invert and release the at least one flocculant into the water. The released flocculant is then added—e.g., by injection—into an aqueous slurry for separation of solids from the slurry water. The surfactant is water-soluble or water-dispersible.

Conventionally, inversion involves adding to a preparation tank a carefully weighed or metered quantity of water, a surfactant (usually at a concentration of from about 0.5 to about 1.0 weight percent, on an active surfactant basis and by weight of the water), and a sufficient quantity of a water-in-oil flocculant-containing emulsion to yield a final flocculant concentration of less than 0.15 weight percent to about 0.4 weight percent or greater, on an active polymer basis, by weight of the water. The mixture is agitated for about one hour or longer until the emulsion fully inverts and releases the flocculant into the water. The flocculant solution is then transferred to a dilution tank, usually via gravity, where it is diluted further, by at least ten-fold. The diluted solution is fed—usually through a pipe of from 25 to 500 feet—into a thickener containing an aqueous slurry where the flocculant promotes separation of solids from liquid. The flocculant is not added to the digester prior to the production of the slurry.

The present invention relates to the addition of the quickly inverting flocculant into the digestion process prior to the formation of the slurry. The quickly inverting flocculant used is produced in a method that reduces the time required for inverting the emulsion: generally, ranging from less than 10 to 30 seconds or greater. Typically, in the practice of this invention, the methods achieve inversion in from about 5 to about 60 seconds; preferably from about 10 to about 30 seconds; and most preferably from about 15 to about 25 seconds. Further, under this invention, inversion may be achieved and the flocculant available for use in considerably shorter pipe lengths than needed in conventional methods; e.g., from less than 3 feet to about 20 feet or greater.

The combination of high shear and a surfactant, selected for its suitable chemistry and employed at a suitable concentration, also eliminates the labor intensity and equipment that typify conventional inversion processes. The preparation tank is no longer needed; nor is the dilution tank. Instead, the released flocculant may be injected directly into the digester prior to the production of a slurry.

The current invention can be used in acidic conditions and in the production of acids. One embodiment uses the claimed invention for the production of phosphoric acid. The claimed invention can be used to aid in the clarification of the acid slurry of the process thereby produce a more purified final product.

The flocculants used in this invention are high molecular weight, anionic, water-soluble or dispersible polymers. The flocculant is micellized within the water phase of the emulsion. Within the micelle, the flocculant is coiled but elongates when released into a bulk water phase. Preparation of Water-in-Oil Emulsions Suitable for Use in this Invention is Generally Known to those skilled in the art.

More than one flocculant and more than one flocculant-containing emulsion may be used in this invention. Both the chemistry and the amount of flocculant needed for a particular application are determined based upon the properties of the slurry such as its nature, the percent solids, the particle size range of the solids, the desired rate of dewatering, settling, pH, and the desired turbidity in the filtrate.

The flocculants in this invention are generally selected from the group consisting of copolymers, homopolymers and terpolymers comprising from 0.01 to 100 mole percent of a vinyl-containing functional monomer. The vinyl-containing functional monomers include, e.g., acrylamide, diallyldimethyl ammonium chloride, acrylic acid and salts thereof, methacrylic acid and salts thereof, dimethylaminoethylacrylate methyl chloride quaternary, dimethylaminoethylmethacrylate methyl chloride quaternary, 2-acrylamido-2-methyl propane sulfonic acid and salts thereof, acrylamido propyl trimethyl ammonium chloride, methacrylamido propyl trimethyl ammonium chloride, and amines prepared by the Mannich reaction. For example, in one embodiment, the flocculant comprises acrylamide and sodium acrylate, present in a mole ratio of from 99:1 to 1:99, preferably from 99:1 to 50:50, and most preferably, from 95:5 to 60:40. In another embodiment, the flocculant is an acrylamide copolymer containing from 10-30 mole percent of 2-acrylamido-2-methyl propane sulfonic acid.

The flocculant may be an anionic, cationic, amphoteric, or non-ionic polymer. Cationic flocculants generally include, but are not limited to, polymers comprising poly (DMAEM.MCQ), poly (DMAEA.MCQ), acrylamide/DMAEA.MCQ copolymers, acrylamide/DMAEM.MCQ copolymers, acrylamide/APTAC copolymers, acrylamide/MAPTAC copolymers, acrylamide/DADMAC copolymers, acrylamide/DADMAC/DMAEA.MCQ terpolymers, AcAm/DMAEA.BCQ/DMAEA.MCQ terpolymers, and copolymers of vinylamine/vinylformamide, as examples. Other examples of cationic functional groups that may be incorporated into cationic flocculants include amines, amidoamines, ethyleneimine, EDC/NH₃, vinylamine, vinylformamide, and the like.

Suitable non-ionic flocculants include, but are not limited to, polyacrylamides, polyvinylpyrrolidone and polyvinylformamides, as examples.

As with the above, virtually any suitable anionic flocculant may be used. Examples of anionic flocculants include, but are not limited to, polyacrylic acid, polyacrylates, poly (meth) acrylates, acrylamide/sodium acrylate copolymers, acrylamide/sodium (meth)acrylate copolymers, acrylamide/acrylamidomethyl propone sulfonic acid copolymers and terpolymers of acrylamide/acrylamidomethyl propone sulfonic acid/sodium acrylate.

Among the amphoteric flocculants suitable for use in this invention are acrylamide/sodium acrylate/DADMAC and acrylamide/DMAEA.MCQ/sodium acrylate, as examples.

The molecular weight of the flocculant can vary and usually ranges from less than about 250,000 to about 30,000,000, or higher. Preferably, the molecular weight ranges from about 10,000,000 to more than about 20,000,000, and most preferably from about 15,000,000 to about 20,000,000.

In 1 M sodium nitrate, the flocculent has a reduced specific viscosity of from about 1 to about 50 deciliters per gram. The reduced specific viscosity is preferably from 10 to 45 deciliters per gram and most preferably from 30 to 36 deciliters per gram.

The amount of flocculant that is incorporated into the emulsion can be optimized to meet the particular demands of the slurry system. The emulsion typically contains from about 5 to about 70 percent of flocculant, by weight, on an active polymer basis. Preferably, on an active polymer basis, the flocculant accounts for about 15 to about 50 percent, by weight, and most preferably, from about 25 to about 40 percent, by weight of the emulsion.

The surfactant in the flocculant product is necessary for inverting the bulk phase of the product from oil to water. Suitable surfactants may be anionic, cationic, non-ionic, or amphoteric. Care must be used in selecting an appropriate surfactant because some surfactants may destabilize the emulsion. In an alternative embodiment, the emulsified flocculant product may contain at least one surfactant.

Although a variety of surfactants may be used for inversion, the surfactants suitable for this invention are hydrophilic and have HLB's of from less than 10 to 40, or greater. Preferably, the HLB's range from about 10 to about 30. Suitable anionic surfactants include, but are not limited to, Bioterge AS-40, comprising 40 percent olefin sulfonate, available from Stepan Co., Northfield, Ill.; Aerosol GPG comprising 70 percent dioctyl ester of sodium sulfosuccinic acid, available from Cytec Industries, West Paterson, N.J.; and Steol® CS 460 comprising 60 percent sodium lauryl ethoxysulfate, available from Stepan Co., Northfield, Ill., as examples.

Suitable non-ionic surfactants include, e.g., ethoxylated octyl phenol, ethoxylated linear alcohol, block copolymers of ethylene oxide and propylene oxide (hereinafter “EO/PO copolymers”), secondary alcohol ethoxylate, modified phenols, polyoxyethylenated alkylphenols, polyoxyethylenated straight-chain alcohols, polyoxyethylenated polyoxypropylene glycols, polyoxyethylenated mercaptans, long-chain carboxylic acid esters, alkanolamides, tertiary acetylenic glycols, polyoxyethylenated silicones, and the like.

These non-ionic surfactants are available commercially or can be readily manufactured using techniques known in the art. One example of a secondary alcohol ethoxylate is Tergitol 15-S-3 from Union Carbide Corp., South Charleston, and W. Va., which has an HLB of about 8. One example of a suitable EO/PO copolymer that comprises 100 percent actives and has an HLB of about 15 is Pluronic L-64 from BASF Corp., Mt Olive, N.J.

Preferred non-ionic surfactants include, e.g., ethoxylated octyl phenol and linear alcohol ethoxylate. Ethoxylated octyl phenol having an HLB of 12.7, trademarked TRITON X-114, is available from Rohm & Haas, Philadelphia, Pa.; and a linear alcohol ethoxylate, trademarked ALFONIC 1412-7, is available from Condea Vista Chemical, located in Houston, Tex.

Suitable cationic surfactants include, but are not limited to, compounds such as Ethomeen® C/15, an ethoxylated amine comprising 100 percent actives, available from Akzo Nobel Chemicals Inc., Chicago, Ill.; and Marlazin T 50/45, a tallow amine polyethylene glycol ether comprising 50 mole percent EO, available from Condea Vista Co., Houston, Tex., as examples.

Several examples of an amphoteric surfactant include but are not limited to Amphoterge® SB, a substituted imidazoline sulfonate, available from Lonza Inc., located in Fair Lawn, N.J.; and Montaric CLV comprising 50 percent actives of disodium cocoamphodiacetate, available from Uniquema (Paterson), Paterson, N.J.

The concentration of surfactant in the emulsion can be adjusted as needed. However, surfactant is typically incorporated into the emulsion at a concentration of from about 1 to about 10 percent, by weight, and preferably from about 2 to about 6 percent, by weight.

Typically, when a surfactant is included in an emulsion, the surfactant is selected to have a density that is substantially close to that of the emulsion matrix so it does not settle out of the emulsion. For example, when the density of an emulsion is within the range of from about 1 to about 1.1 grams per cubic centimeter (g/cc), the surfactant should have a density within that range or, e.g., within the range of from about 1.02 to about 1.06 g/cc.

In the emulsion, the surfactant does not dissolve, otherwise solubilize, or react with the micellized flocculant in the water phase. In fact, it is not until the emulsion is introduced into an aqueous system and subjected to turbulent inverse flow that the surfactant, in synergistic combination with the turbulent flow, causes the emulsion to invert and release the flocculant into the water.

The foregoing descriptions presented solely to illustrate the invention and are not intended to limit the invention, as many variations will become apparent to those skilled in the art in view thereof.

What is claimed is:

1. A method using a quickly inverting flocculant for solids and liquid separation in aqueous slurries, the method comprising adding at least one quickly inverting flocculant into a digestion process prior to or during the formation of an aqueous slurry for separation of solids from water in the slurry wherein the quickly inverting flocculant is produced by dosing water with an effective flocculating amount of at least one water-in-oil water emulsion comprising at least one flocculant and at least one hydrophilic surfactant, said surfactant being present in the emulsion at a concentration of from about 1 to about 10 percent, by weight; subjecting the water and the emulsion-containing water to high shear, comprising a turbulent reverse flow, at a sufficient pressure and for a sufficient time for the at least one emulsion to invert and release the at least one flocculant into the water.

2. The method of claim 1 wherein the quickly inverting flocculant is a polymer selected from the group consisting of copolymers, homopolymers, and terpolymers comprising from 0.01 to 100 mole percent of a vinyl-containing functional monomer.

3. The method of claim 2 wherein the vinyl-containing functional monomer is selected from the group consisting of acrylamide, diallyldimethyl ammonium chloride, acrylic acid and salts thereof, methacrylic acid and salts thereof, dimethylaminoethylacrylate methyl chloride quaternary, dimethylaminoethylmethacrylate methyl chloride quaternary, 2-acrylamido-2-methyl propane sulfonic acid and salts thereof, acrylamido propyl trimethyl ammonium chloride, methacrylamido propyl trimethyl ammonium chloride, and amines prepared by the Mannich reaction.

4. The method of claim 1 wherein the quickly inverting flocculant has a reduced specific viscosity of from about 1 to about 50 deciliters per gram.

5. The method of claim 1 wherein the quickly inverting flocculant has a molecular weight of from about 250,000 to about 30,000,000.

6. The method of claim 1 wherein the quickly inverting flocculant is in an emulsion with a surfactant from about 5 to about 70 percent, by weight, on an active polymer basis.

7. The method of claim 6 wherein the surfactant is selected from the group consisting of anionic, cationic, non-ionic, or amphoteric surfactants having an HLB of from about 10 to about 30.

8. The method of claim 6 wherein the surfactant includes at least one surfactant selected from the group consisting of ethoxylated octyl phenol and linear alcohol ethoxylate.

9. The method of claim 8 wherein the surfactant is ethoxylated octyl phenol.

10. The method of claim 8 wherein the emulsion further comprises at least one high terpene content natural oil.

11. The method of claim 10 wherein the high terpene content natural oil is selected from the group consisting of citrus peel oil and pine oil.

12. The method of claim 11 wherein the citrus peel oil is selected from the group consisting of orange oil, lemon oil, grapefruit oil, and lime oil.

13. The method of claim 1 wherein the quickly inverting flocculent is dosed into the digestor.

14. The method of claim 1 wherein the shear is a turbulent reverse flow produced by an in-line inverting device.

15. The method of claim 1 wherein the quickly inverting flocculent is added to promote separation of solids from water, wherein the solids are selected from the group consisting of coal, clean coal, bauxite, iron ore, copper ore, sand, gravel, clay, dirt, lead/zinc, phosphate rock, taconite, beryllium, trona, kaolin, titania, uranium, and precious metals.

16. The method of claim 1 wherein the quickly inverting flocculant is added to promote separation of solids from liquid under acidic conditions.

17. The method of claim 1 wherein the quickly inverting flocculant is added to promote separation of solids from liquid for the production of acid.

18. The method of claim 17 wherein the quickly inverting flocculant is added to promote separation of solids from liquid for the production of phosphoric acid.
